(19) United States
(12) Patent Application Publication
(10) Pub. No.: US 2009/0244757 A1
(43) Pub. Date: Oct. 1, 2009

(54) Methods and Apparatus for Low Power Hard Disk Drive Servo Writers

(76) Inventors: Marius Vicentiu Dina, Burnsville, MN (US); Jeremy Robert Kuehlwein, Woodbury, MN (US)

Correspondence Address: TEXAS INSTRUMENTS INCORPORATED, P O BOX 655474, M/S 3999, DALLAS, TX, 75265, US

(21) Appl. No.: 12/059,527

(22) Filed: Mar. 31, 2008

(51) Int. Cl. G11B 5/09

(52) U.S. Cl. 360/42

(57) ABSTRACT

Methods and apparatus to for low power hard disk drive servo writers. A disclosed servo writer comprises a distribution circuit to receive one or more pulses from a pulse generator, the distribution circuit having a biasing circuit have one of a first write mode or a second write mode based on an operating condition signal; and a first signal generator to form a first write signal and a second signal generator to form a second write signal, the first and second signal generators being actuated by the distribution circuit, wherein the distribution circuit actuates one of the first and second signal generators in the first write mode and the distribution circuit actuates the first and second signal generators in the second write mode.

### FIELD OF THE DISCLOSURE

This disclosure relates generally to hard disk drives and, more particularly, to methods and apparatus for low power hard disk drive servo writers.

### BACKGROUND

A hard disk drive (HDD) is a non-volatile storage device that stores digitally encoded data on spinning platters with an associated magnetic surface. Generally, a HDD includes a spindle that holds one or more platters having a magnetic surface, which spins at a constant speed (e.g., 10,000 revolutions per minute (rpm), 7,200 rpm, or 5,400 rpm). The HDD includes one or more actuator arms that moves radially across the spinning platters and include corresponding read heads to read data therefrom and corresponding write heads to write data thereto.

The platters of the HDD also have servo sectors arranged at predetermined intervals to store servo information thereon, which is read by a HDD read system. Using the servo information, a HDD controller determines the location of the read and write heads and adjusts the position of the actuator arms to the desired location. Once the read heads and write heads are at the desired location relative to the spinning platters, the HDD read system either reads information therefrom or a HDD write system writes information thereto. Generally, the servo information is recorded at substantially the same location on the platters in a controlled environment (e.g., 25° C., etc.). Thus, the write heads of the HDD are actuated at the same time to write the servo information to the platters.

The HDD write system is configured to write user data to the platters at high speeds, such as 3 gigabits per second. Due to the high speed of the write operation, the HDD write system consumes a significant amount of power to actuate one of the write heads. Thus, actuating each of the write heads to write servo information increases the temperature of the HDD, thereby introducing errors into the servo information on the platters. As a result, the HDD includes a separate HDD servo write system. The HDD servo write system writes the servo information at a lower speed, such as 1 gigabit per second and does not consume significant amounts of power. Such a HDD servo write system is located on a different integrated circuit and, due to its low power operation, actuates each of the write heads at the same time to write the servo information to the platters.

### BRIEF DESCRIPTION OF THE DRAWINGS

FIG. 1 is an illustration of a hard disk drive.

FIG. 2 is a block diagram of an example hard disk drive write system.

FIG. 3 illustrates an example HDD write signal formed by the example hard disk drive write system of FIG. 2.

FIG. 4 is a block diagram of an example signal generator of FIG. 2.

FIG. 5 is a schematic diagram of the example distribution circuit of FIG. 2.

FIG. 6 is a schematic diagram of the example switching circuit of FIG. 4.

FIG. 7 is a schematic diagram of the example buffer of FIG. 6.

### DETAILED DESCRIPTION

Methods and apparatus for low power hard disk drive (HDD) servo writers are disclosed. In the described examples, the HDD writers are configured in a high power current mode to write to user data and the HDD writers are configured in a low power voltage mode to write servo information. Although the example methods and apparatus described herein generally relate to hard disk drives, the disclosure is not limited to such. On the contrary, the teachings of this disclosure may be applied in any device that would benefit from selectively configuring devices in voltage modes and current modes.

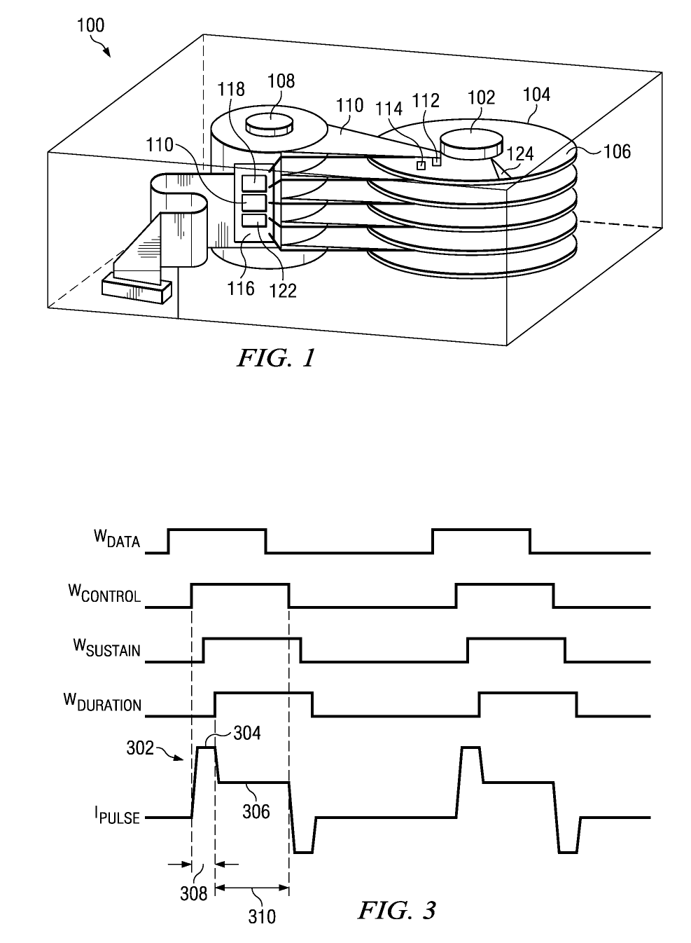

FIG. 1 illustrates an example HDD 100. As shown in example of FIG. 1, the HDD 100 includes a spindle 102 that holds one or more platters 104 having a magnetic surface 106, which spins at a constant speed (e.g., 10,000 revolutions per minute (rpm), 7,200 rpm, or 5,400 rpm). To read and write data from the platters 104, the HDD 100 includes a servo system 108 that moves one or more actuator arms 110 associated with the platters 104 (i.e., each platter 104 has a corresponding actuator arm 110). The actuator arms 110 include one or more read heads 112 and one or more write heads 114 to read or write data (i.e., digitally encoded information) on the platters 104.

The read heads 112 and the write heads 114 are coupled to a HDD controller 116 that includes a HDD read system 118, a HDD write system 120, and a HDD servo controller 122. To either read or write data on the platters 104, the HDD controller 116 must determine position the read heads 112 or write heads 114. As a result, the platters 104 generally include servo sectors 124 on the platter 104 that have servo information stored therein. The servo information contains position data to facilitate the movement of the read heads 112 or write heads 114. In particular, the servo information is read by the read head 112 and conveyed to the HDD read system 118. The servo information is then conditioned (e.g., amplified, filtered, etc.) and conveyed to the HDD servo controller 122, which determines the location of the read head 112. In response to the servo information, the servo controller 122 causes the actuator arms 110 to move the read heads 112 and write heads 112 to the desired location relative to the platters 104.

In the illustrated example, the HDD write system 120 has two write modes to write data to the platters 104 of the HDD 100. The HDD write system 120 includes a high speed, high power channel write mode to write user data to one of the platters 104. The HDD write system 120 also includes a low speed, low power servo write mode to write servo information to the platters 104. The servo write mode configures the HDD write system 120 to write the servo information at substantially the same location on the platters 104.

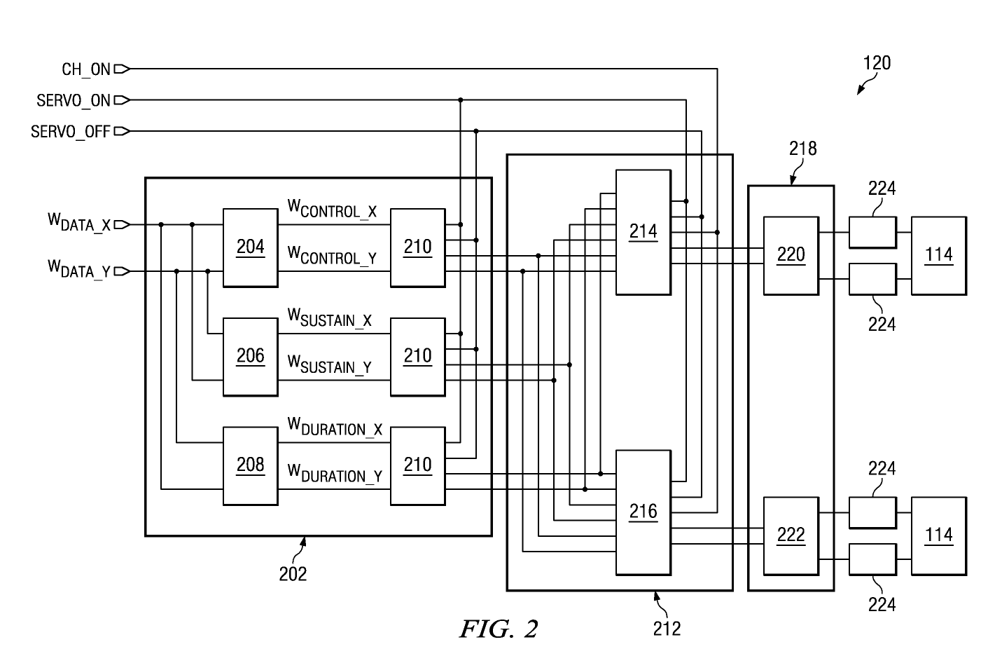

FIG. 2 illustrates a block diagram of an example HDD write system 120 to selectively write data to the platters 104. In the illustrated example, the HDD write system 120 is a differential system that receives a differential write data signal (W_{DATA}_{_{—}}_{X} and W_{DATA}_{_{—}}_{Y}), which represents the data to be stored on the HDD 100. The differential write data signal is conveyed by two signals (W_{DATA}_{_{—}}_{X} and W_{DATA}_{_{—}}_{Y}) and the magnitude of the signal is the difference between the signals. As such, for each differential signal, there are two circuits (e.g., a differential pair of transistors) to accommodate the differential signal.

In the example of FIG. 2, the HDD write system 120 includes a pulse forming stage 202, which generates a plurality of delayed pulses based on the differential input write data signal. The pulse forming stage 202 includes a first pulse generator 204, a second pulse generator 206, and a third pulse generator 208, which are coupled to one or more respective distribution circuits 210. The distribution circuits 210 are coupled to a signal generating stage 212. More particularly, the distribution circuits 210 are coupled to a first signal generator 214 and a second signal generator 216 of the pulse generating stage 212.

The distribution circuits 210 receive both a SERVO_ON signal and a SERVO_OFF. The SERVO_OFF is generally an inverted SERVO_ON signal, and, therefore, the signals are mutually exclusive. In other words, when the SERVO_ON signal is on (e.g., three volts, etc.), then the SERVO_OFF signal is off (e.g., zero volts, etc.). As will be described below, the SERVO_ON signal and SERVO_OFF signal selectively configure the distribution circuits 210 in either the current mode or the voltage mode.

In the illustrated example, the current mode operation of the distribution circuits 210 cause the HDD write system 120 to be in the channel write mode and the voltage mode operation of the distribution circuits 210 cause the HDD write system 120 to be in the servo write mode. In addition, the signal generators 214 and 216 both receive the SERVO_ON signal and the SERVO_OFF signal to selectively configure the signal generators 214 and 216 in the current mode or the voltage mode. However, in the channel write mode, one of the signal generators 214 and 216 is selectively configured in the current mode by receiving a CH_ON signal, thereby allowing the HDD write system 120 to write user data to the corresponding write head 114.

In the example of FIG. 2, the signal generating stage 212 is coupled to a driver stage 218. In particular, the first signal generator 214 is coupled to a first driver 220 and the second signal generator 216 is coupled to a second driver 222. The drivers 220 and 222 are coupled to respective write heads 114 via transmission lines 224.

In the operation of the HDD write system 120, the pulse forming stage 202 generates a plurality of delayed pulses based on the differential input write data. In the example of FIG. 2, the pulse generator 204 forms a write control signal (W_{CONTROL}_{_{—}}_{X} and W_{CONTROL}_{_{—}}_{Y}), the pulse generator 206 forms a write sustain control signal (W_{SUSTAIN}_{_{—}}_{X} and W_{SUSTAIN}_{_{—}}_{Y}), and the pulse generator 208 forms a write duration control signal (W_{DURATION}_{_{—}}_{X} and W_{DURATION}_{_{—}}_{Y}). As illustrated in the example of FIG. 3, the pulses formed by the pulse generators 204, 206, and 208 are delayed pulses based on the write data signal (W_{DATA}_{_{—}}_{X} and W_{DATA}_{_{—}}_{Y}). Further, the leading and trailing edges of the write control signal, the write sustain control signal, and the write duration control signal are used to form the HDD write signal in the signal generators 214 and 216.

Referring to the example of FIG. 2, the write control signal, the write sustain control signal, and the write duration control signal are conveyed to their respective distribution circuits 210. The distribution circuits 210 selectively distribute the pulses to a first signal generator 214 and a second signal generator 216 based on the operating mode of the HDD write system 120. In the illustrated example, the distribution circuits 210 selectively distribute the pulses of the signal generators 214 and 216 via either a voltage mode or a current mode.

In the current mode, the distribution circuits 210 sink a predetermined amount of current from one of the signal generators 214 and 216. By sinking the current, one of the signal generators 214 and 216 is in a high speed, high power write mode (e.g., 3 gigabits per second). In the illustrated example, because the distribution circuits 210 sink a predetermined current, the CH_ON signal selectively configures one of the signal generators 214 and 216 to provide the current to the distribution circuits 210. The current mode operation is preferable for high speed operation because it is not susceptible to parasitics such as line (i.e., trace) capacitances, and so forth. In other words, the distribution circuits 210 are placed in the current mode to configure the HDD write system 120 in the channel write mode.

On the other hand, in the voltage mode, the distribution circuits 210 sets a voltage at the signal generators 214 and 216. In response to the voltage mode, the signal generators 214 and 216 are in a low speed, low power write mode (e.g., 1 gigabit per second). The voltage mode operation is preferable for low speed operation because the voltage mode does not consume a substantial amount of power. Thus, the distribution circuits 210 are placed in the voltage mode to configure the HDD write system 120 in the servo write mode.

The signal generators 214 and 216 selectively receive the pulses via the distribution circuits and, in response, form the HDD write signals, which are typically implemented by current pulses. FIG. 3 illustrates an example HDD write signal 302 formed by the example signal generators 214 and 216 in more detail. In the illustrated example, the HDD write signal 302 has an overshoot portion 304 that has a current magnitude substantially equal to a predetermined overshoot value and a sustain portion 306 has a current magnitude that is a portion of the overshoot value. More particularly, the overshoot portion has a duration 308 that is based on the time period between the leading edge of the write control signal (W_{CONTROL}_{_{—}}_{X} and W_{CONTROL}_{_{—}}_{Y}) and the leading edge of the write duration control signal (W_{SUSTAIN}_{_{—}}_{X} and W_{SUSTAIN}_{_{—}}_{Y}). The sustain portion has a duration 310 based on the time period between the leading edge of the write duration control signal (W_{SUSTAIN}_{_{—}}_{X} and W_{SUSTAIN}_{_{—}}_{Y}) and the trailing edge of the write control signal (W_{CONTROL}_{_{—}}_{X} and W_{CONTROL}_{_{—}}_{Y}).

After generating the HDD write signals, the signal generators 214 and 216 convey the HDD write signals to the drivers 220 and 222, respectively. The drivers 220 and 222 amplify and condition the HDD write signals. After conditioning the HDD write signals, the drivers 220 and 222 convey the HDD write signals to their respective write heads 114 via the transmission lines 224, thereby writing data contained in the write data signal (W_{DATA}_{_{—}}_{X} and W_{DATA}_{_{—}}_{Y}) to the platters 104.

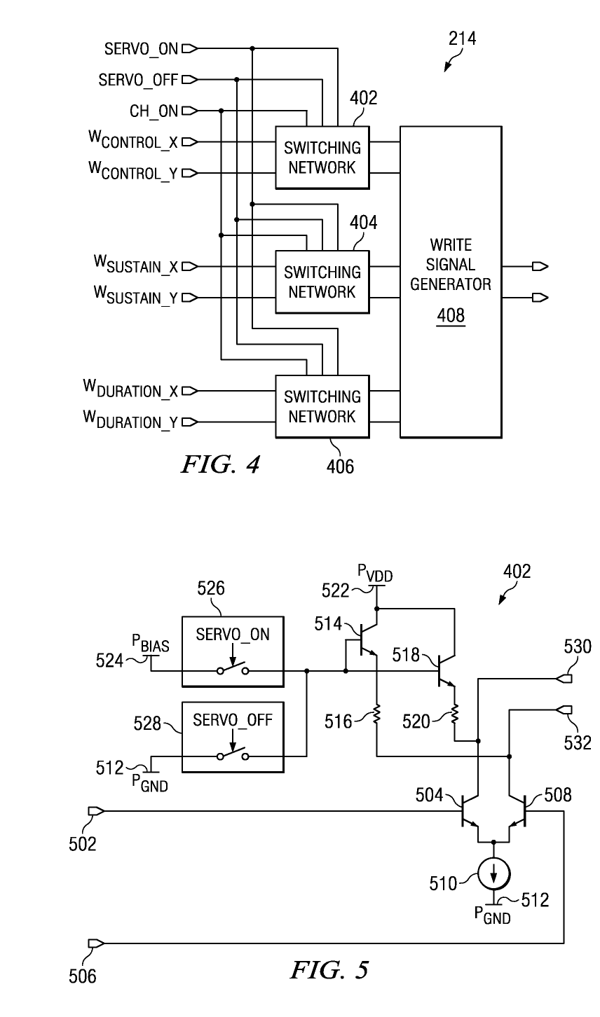

FIG. 4 illustrates the example signal generator 214 in more detail. In the illustrated example, the signal generator 214 includes a first switching network 402 to receive the write control signal, a second switching network 404 to receive the write sustain control signal, and a third switching network 406 to receive the write duration control signal. In addition, the switching networks 402, 404, and 406 receive the SERVO_OFF signal, the SERVO_ON signal, and the CH_ON signal. The switching networks 402, 404, and 406 selectively convey the received signals based on the write mode of the HDD write system 120 to a write signal generator 408, which generates the HDD write signal in response to the received signals.

In particular, in the event the switching networks 402, 404, and 406 receive the SERVO_ON signal, the switching networks 402, 404, and 406 are in the voltage mode and configure the write signal generator 408 to form the HDD write signal. In such an example, the first and second signal generators 214 and 216 are configured to generate HDD write signals. In other words, the servo mode enables information to be written to each of the platters 204 at the same time. On the other hand, in the event the switching networks 402, 404, and 406 receive the SERVO_OFF signal, the switching networks 402, 404, and 406 are in the current mode and selectively configure the write signal generator 408 to generate the HDD write signal based on the CH_ON signal. As described above, in the current mode, one of the signal generators 214 and 216 is selectively actuated to generate the HDD write signal by receiving the CH_ON signal.

FIG. 5 is a schematic diagram of an example distribution circuit 210 of the pulse generating stage 202. As described above, the distribution circuit 210 operates in either a voltage mode or a current mode. More particularly, the distribution circuit 210 either sinks a predetermined current from the signal generators 214 and 216 or causes the signal generators 214 and 216 to have a voltage.

A first input 502 is coupled to the base of a transistor 504 (e.g., an NPN transistor, etc.) and a second input 506 is coupled to the base of a transistor 508 (e.g., an NPN transistor, etc.). The emitters of both transistors 506, 508 are coupled to a current sink 510, which is further coupled to a reference signal 512 P_{GND} (e.g., ground, etc.). The drain of the transistor 504 is coupled to the emitter of a transistor 514 (e.g., an NPN transistor, etc.) via a resistor 516 and the drain of the transistor 508 is coupled to the emitter of a transistor 518 (e.g., an NPN transistor, etc.) via a resistor 520. The collectors of both transistors 514 and 518 are coupled to a power source P_{VDD} 522.

The bases of both transistors 514 and 518 are selectively coupled to a bias source P_{BIAS} 524 and the reference signal 512 via first and second switches 526 and 528, respectively. In the illustrated example, the first and second switches 526 and 528 are implemented by any suitable switch (e.g., a transistor, a metal oxide semiconductor field effect transistor (MOSFET), etc.) and are biased by a signal indicative of a write mode such as the SERVO_ON and the SERVO_OFF signal, for example.

In particular, the first switch 526 is biased via the SERVO_ON signal and therefore couples the bases of the transistors 514 and 518 to the bias source 524 in response to the SERVO_ON signal. The second switch 518 is biased via the SERVO_OFF signal and therefore couples the bases of the transistors 514 and 518 to the reference signal 512 in response to the SERVO_OFF signal. That is, the transistors 514 and 518 turn on in response to the SERVO_ON signal and the transistors 514 and 518 turn off in response to the SERVO_OFF signal. In the illustrated example, the emitters of the transistors 504 and 508 are also coupled to a third input 530 and a fourth input 532, respectively.

In the operation of the example of FIG. 5, the distribution circuit 210, in response to a pulse from its respective pulse generator 310, attempts to sink a predetermined current via the third and fourth inputs 530 and 532. In particular, the pulses received via the inputs 502 and 506 cause the transistors 504 and 508 to have a high base-emitter voltage (V_{BE}). In response, the transistors 504 and 508 turn on and attempt to draw current. Of course, when the inputs 502 and 506 do not receive a pulse, the transistors 504 and 508 are turned off and the distribution circuit 210 cannot sink current via the inputs 530 and 532. That is, when the distribution circuit 210 does not receive a pulse, the distribution circuit 210 is turned off. However, when the distribution circuit 210 does receive a pulse via its inputs 502 and 506, the distribution circuit 210 is turned on to allow writing to the HDD 200.

In the event the SERVO_OFF signal is provided to the distribution circuit 210, the SERVO_OFF signal biases and closes the switch 528. At the same time, the distribution circuit 210 does not receive the SERVO_ON signal and the switch 526 is therefore open. That is, when the SERVO_OFF signal biases the switch 528, the bases of both transistors 514 and 518 are coupled to the reference signal 512 via the switch 528 and have a low base-emitter voltage (V_{BE}). As a result, both transistors 514 and 518 have a low base-emitter voltage and are turned off. As a result, the transistors 504 and 508 attempt to draw current from the inputs 530 and 532.

Thus, in response to the SERVO_OFF signal, the distribution circuit 210 is in the current mode and attempts to sink a predetermined current to the transistors 504 and 508. The current mode operation of the signal generators 314 is preferred for writing data due to parasitic capacitances in the lines (e.g., traces) between the distribution circuit 210 and the signal generating stage 212. The presence of parasitic capacitances cause time constants in the lines and slow down the transmission of signals. In the current mode, however, one of the signal generators 214 and 216 is selectively actuated to provide the current to the distribution circuit 210.

However, in the event the SERVO_ON signal is provided to the distribution network 312, the SERVO_ON signal biases and closes the switch 526. At the same time, the distribution circuit 210 does not receive the SERVO_OFF signal and the switch 528 is therefore open. That is, in response to the SERVO_ON signal, the transistors 514 and 518 are coupled to the bias source 532 and have a low base-emitter voltage, thereby turning on the transistors 514 and 518. Thus, the transistors 514 and 518 provide the predetermined current to the transistors 504 and 508 in response to the SERVO_ON signal and, as a result, the current flows across the resistors 516 and 520. The current flowing across the resistors 516 and 518 sets a voltage at the inputs 530 and 532 of the distribution circuit 312. Thus, in response to the SERVO_ON signal, the distribution circuit 210 is in the voltage mode and does not sink current from the signal generating stage 212.

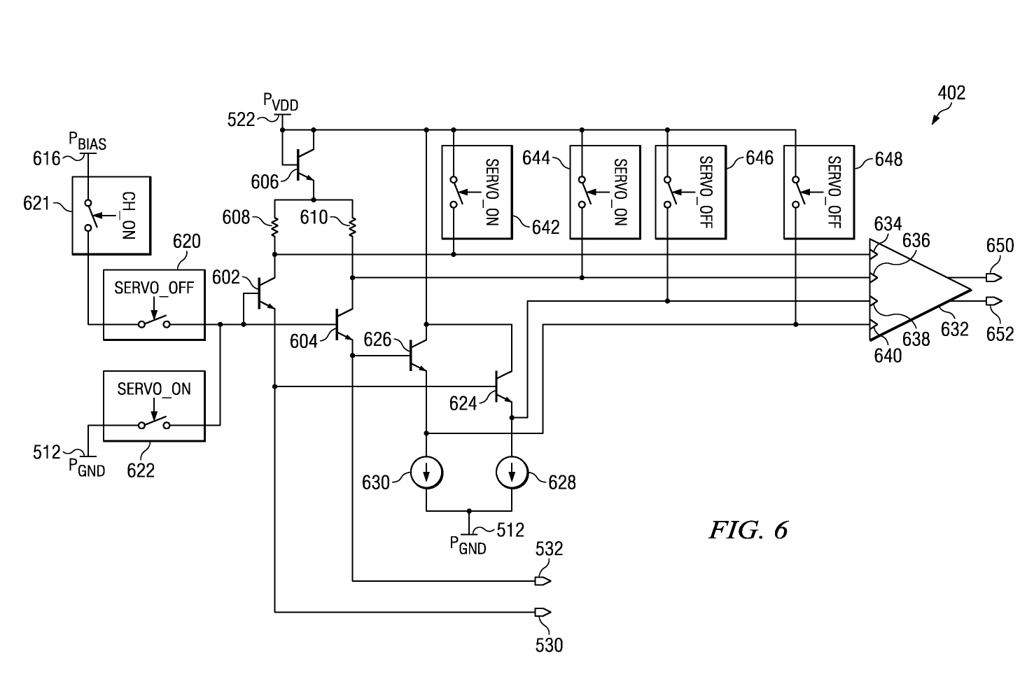

FIG. 6 is a schematic diagram of an example switching circuit 402 of the signal generator 214. The switching circuit 402 is coupled to the inputs 530 and 532 of the distribution circuit 210. The input 530 of the distribution circuit 210 is coupled to the emitter of a transistor 602 (e.g., an NPN transistor, a MOSFET, etc.) and the input 532 of the distribution circuit 210 is coupled to the emitter of a transistor 604 (e.g., an NPN transistor, a MOSFET, etc.). The transistors 602 and 604 form a differential transistor pair and selectively enable current to flow to the inputs 530 and 532 of the distribution circuit 210. The collectors of the transistors 602 and 604 are both coupled to the emitter of a transistor 606 via resistors 608 and 610, respectively. The transistor 606 is coupled to the power source 522 via both its base and collector.

The base of the transistors 602 and 604 are coupled to a bias source P_{BIAS} 616 via a first switch 620 and a second switch 621 that are connected in series. In the illustrated example, the first and second switches 620 and 621 are implemented by any suitable type of switch (e.g., a transistor, a MOSFET, etc.) and are biased by the SERVO_OFF signal and the CH_ON signal, respectively. As described above, the CH_ON signal is a signal indicative of a channel write mode, which selectively causes the signal generators 214 and 216 to write data to their respective platters 104. The bases of the transistors 602 and 604 are coupled to the reference signal 512 via a third switch 622, which is biased by the SERVO_OFF signal.

The emitter of the transistor 602 is also coupled to the base of a transistor 624 and the emitter of the transistor 604 is coupled to the base of a transistor 626. In the illustrated example, the emitters of the transistors 624 and 626 are coupled to the reference signal 512 via first and second current sinks 628, 630, respectively. The collectors of both transistors 624 and 626 are both coupled to the power source 522. That is, the transistors 624 and 626 sink a predetermined current into the reference signal 512.

The example of FIG. 6 includes a buffer 632 to selectively enable writing to the platter 204 of the HDD 200. In the illustrated example, the buffer 632 has first and second inputs 634 and 636 to detect a first differential voltage and third and fourth inputs 638 and 640 to detect a second differential voltage. In particular, the first input 634 of the buffer 632 is coupled to the collector of the transistor 602 and the second input 636 of the buffer 632 is coupled to the collector of the transistor 604. The first input 634 of the buffer 632 is also coupled to the power source 522 via a switch 642 and the second input 636 of the buffer 632 is coupled to the power source 522 via a switch 644. Both switches 642 and 644 are biased via the SERVO_ON signal.

The third input 638 of the buffer 632 is coupled to the emitters of the transistor 624 and the fourth input 640 of the buffer 632 is coupled to the emitters of the transistor 626. The third input 638 of the buffer 632 is also coupled to the power source 522 via a switch 646 and the fourth input 640 of the buffer 632 is coupled to the power source 522 via a switch 648. Both switches 642 and 644 are biased via the SERVO_OFF signal. The buffer 632 conveys a differential output via a first output 650 and a second output 652, which coupled to the write signal generator 408.

The signal generators 214 and 216 are in the servo write mode in response to the SERVO_ON signal. As described above, in response to the SERVO_ON signal, the distribution circuit 210 causes the inputs of the distribution circuit 210 to have a voltage. At the same time, the SERVO_ON signal biases and closes the switch 622, therefore coupling the bases of the transistors 602 and 604 to the reference signal 512. As a result, the transistors 602 and 604 have a low base-emitter voltage and are turned off. Thus, current cannot flow into the distribution circuit 210 via the transistors 602 and 604.

However, the emitters of the transistors 602 and 604 will have a corresponding voltage. As a result, the bases of the transistors 624 and 626 will have a high base-emitter voltage and turn on in response. The current sources 628 and 630 limit the current flowing through the transistors 624 and 626, respectively, and, as a result, have substantially equal voltages at their respective emitters. Of course, the voltage at the emitters of the transistors 624 and 626 is less than the voltage of the power source 522. The SERVO_ON signal also biases the switches 642 and 644 closed and couple the power source 522 to the first and second inputs 634 and 636 of the buffer 632. The switches 646 and 648 do not receive the SERVO_OFF signal and both are therefore open.

That is, the first and second inputs 634 and 636 of the buffer 632 have a voltage substantially equal to the power source 522 and the third and fourth inputs 638 and 640 of the buffer 632 have a voltage less than the voltage of the power source 522. In this configuration, the buffer 632 is enabled to form a signal based on the third and fourth inputs 638 and 640. Thus, in response to the SERVO_ON signal, the distribution circuits 210 cause the signal generators 214 and 216 to form HDD write signals based on the pulses received via the pulse generating stage 202.

The signal generators 214 and 216 are in the channel write mode in response to the SERVO_OFF signal. More particularly, the signal generator 214 and 216 are selectively actuated to write data to their respective platter 104 in the channel write mode. As described above, in the current mode, the distribution circuits 210 sinks a predetermined current via the signal generating stage 212 in response to the SERVO_OFF signal. In particular, the distribution circuits 210 attempt to sink the current from the first switching network 502, the second switching network 504, and the third switching network 506.

To source the current to the distribution circuits, the switching circuit 502 receives the SERVO_OFF to bias and close the switch 620 and also receives the CH_ON signal to bias and close the switch 621. The switch 622 does not receive the SERVO_ON signal and is therefore open. Thus, in response to the SERVO_OFF signal and the CH_ON signal, the bases of the transistors 602 and 604 are coupled to the bias source 616, which causes the transistors 602 and 604 to have a high base-emitter voltage. The transistors 602 and 604 thereby turn on and allow current to flow into the inputs of the distribution circuit 210. In the example of FIG. 6, the transistors 602 and 604 source current from the power source 522 via the transistor 606, which is configured as a diode to prevent current from flowing into the power source 522. The current is drawn across the resistors 608 and 610 to cause a voltage drop, thereby causing the emitters of the transistors 602 and 604 to have a voltage less than the voltage of the power source 522.

At the same time, the switches 642 and 644 do not receive the SERVO_ON signal and are therefore open. As a result, the first and second inputs 634 and 636 of the buffer 632 have a voltage substantially equal to the voltage of the emitters of the transistors 602 and 604, respectively. However, the switches 646 and 648 receive the SERVO_OFF signal and couple the third and fourth inputs 638 and 640 of the buffer 632 to the power source 522. Further, the SERVO_OFF signal causes the emitters of the transistors 624 and 626 to be substantially equal to the voltage of the power source 522, thereby turning the transistors 624 and 626 off because the voltage at the bases of the transistors 624 and 626 is less than the voltage at their respective emitters.

In this configuration, the buffer 632 is enabled to form a signal based on its first and second inputs 634 and 636. Thus, in response to the SERVO_OFF signal, the CH_ON signal, and the pulses formed by the pulse generating stage 202, the distribution circuits 210 selectively actuate one of the signal generators 214 and 216 to form a HDD write signal based on the pulses received via the pulse generating stage 202.

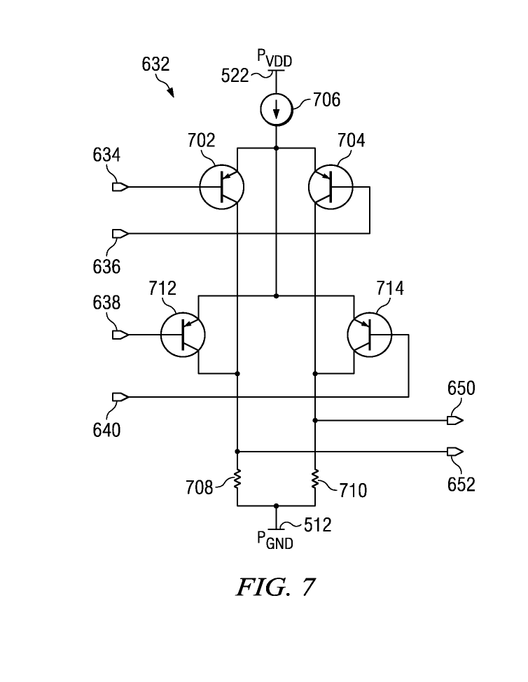

FIG. 7 is a schematic of an example buffer 632, which receives two differential inputs and outputs a differential output. The first input 634 is coupled to a transistor 702 (e.g., a PNP transistor, etc.) and the second input 636 is coupled to the transistor 704 (e.g., a PNP transistor, etc.), both of which receive a first differential input via their respective bases. The emitters of the transistors 702 and 704 are both coupled to a power source 522 via a current source 706, which attempts to source a predetermined current from the power source 522. The emitters of the transistors 702 and 704 are both coupled to the reference signal 512 via resistors 708 and 710, respectively.

In addition, the third input 638 of the buffer 632 is coupled to a transistor 712 (e.g., a PNP transistor, etc.) and the second input 640 of the buffer 632 is coupled to the transistor 714 (e.g., a PNP transistor, etc.), both of which receive the differential input via their respective bases. The emitters of the transistors 712 and 714 are also both coupled to a power source 522 via the current source 706. The emitters of the transistors 702 and 704 are also coupled to the reference signal 512 via the resistors 708 and 710, respectively. That is, the emitters of the transistors 702 and 712 are coupled together and the emitters of the transistors 704 and 714 are coupled together. The first output 650 is coupled to the emitters of the transistors 702 and 712 and the second output 652 is coupled to the emitters of the transistors 704 and 714.

As described above, in response to the SERVO_ON signal, the switching circuit 502 causes the first and second inputs 634 and 636 to have a voltage substantially equal to the voltage of the power source 522. As a result, the base-emitter voltage of the transistors 702 and 704 is low and are therefore turned off. However, at the same time, the voltage of the power source 522 exceeds the voltage of the third and fourth inputs 638 and 640 and, as a result, the transistors 712 and 714 are turned on. Therefore, the transistors 712 and 714 cause a current to flow across the resistors 708 and 710, thereby causing the outputs 650 and 652 to have a differential voltage based on the pulses conveyed via the pulse generating stage 202.

Further, in response to the SERVO_OFF signal, the signal generator 314 causes the voltage at the third and fourth inputs 638 and 640 to be substantially equal to the power source 522. As a result, the transistors 712 and 714 are turned off. However, the voltage of the first and second inputs 634 and 636 is based on the signals provided via the pulse generating stage 202, which is less than the voltage of the power source 522. As a result, the transistors 702 and 704 are turned on and draw the predetermined current from the power source 522. Thus, the predetermined current flows into the resistors 708 and 710 and causes the outputs 650 and 652 to have a differential voltage based on the pulses conveyed via the pulse generating stage 202.

HDD write systems having a servo write mode and a channel write mode have been disclosed. In the described examples, the HDD write system includes a low power servo write mode by placing the HDD write system in a voltage mode. As a result, the servo information is written with the same integrated circuit that reads and writes information to the HDD, thereby eliminating the need for an external servo writer and reducing the circuitry. In addition, because the servo information is written via the same integrated circuit, the disclosed servo writer improves matching and timing because the servo information was written by the same integrated circuit. Further, the servo writers are easy to implement into existing hard disk drives and remove complex circuits and controls associated with the external servo writers.

Although certain methods, systems, and articles of manufacture have been described herein, the scope of coverage of this patent is not limited thereto. To the contrary, this patent covers all methods, systems, and articles of manufacture fairly falling within the scope of the appended claims either literally or under the doctrine of equivalents.

What is claimed is:

1. A method for writing servo information in a hard disk drive signal generator, comprising:
generating one or more pulses in response to data to be written to a hard disk drive;
selecting one of a first write mode and a second write mode based on an operating condition signal;
forming a first hard disk drive write signal via a first signal generator in response to the first write mode; and
forming the first hard disk drive write signal via the first signal generator and a second hard disk drive write signal via a second signal generator in response to the second writing mode.

2. A method as defined in claim 1, wherein selecting the first write mode comprises setting the first signal generator in a current mode.

3. A method as defined in 2, wherein setting the current mode comprises forcing the first signal generator to provide a current substantially equal to a predetermined current to a distribution circuit.

4. A method as defined in claim 2, further comprising writing the data to a first platter associated with the first signal generator.

5. A method as defined in claim 1, wherein selecting the second write mode comprises setting the first and second signal generators in a voltage mode.

6. A method as defined in 5, wherein setting the voltage mode comprises forcing the first signal generator to have a voltage substantially equal to a predetermined voltage of a distribution circuit.

7. A method as defined in claim 5, further comprising writing the data to a first platter associated with the first signal generator and a second platter associated with the second signal generator, the first platter being different than the second platter.

8. A servo writer in a to write servo information in a hard disk drive, comprising:
a distribution circuit to receive one or more pulses from a pulse generator, the distribution circuit having a biasing circuit have one of a first write mode or a second write mode based on an operating condition signal; and
a first signal generator to form a first write signal and a second signal generator to form a second write signal, the first and second signal generators being actuated by the distribution circuit, wherein the distribution circuit actuates one of the first and second signal generators in the first write mode and the distribution circuit actuates the first and second signal generators in the second write mode.

9. A servo writer as defined in claim 8, wherein the distribution circuit is to have a current substantially equal to a predetermined current in response to the first write mode.

10. A servo writer as defined in claim 9, wherein a first switch of the first signal generator is to selectively provide the current to the distribution circuit in response to the operating condition signal.

11. A servo writer as defined in claim 8, wherein the distribution circuit is to have a voltage substantially equal to a predetermined voltage in response to the second write mode.

12. A servo writer as defined in claim 11, wherein the distribution circuit is to cause the first and second signal generators to have a voltage substantially equal to the predetermined voltage in response to the second write mode.

13. A servo writer as defined in claim 8, wherein the signal generators are to have a first write speed in response to the first write mode and the signal generator is to have a second write speed in response to the second write frequency, the second write speed being less than the first write speed.

14. A servo writer as defined in claim 8, wherein the first signal generator is to write to a first platter having a magnetic surface and the second signal generator is to write a second platter having a magnetic surface, the second platter being different than the first platter.

15. A servo writer as defined in claim 8, the signal generators having a switching circuit to select one of a voltage mode operation and a current mode operation based on an input operating condition.

16. A servo writer in a hard disk drive write system, comprising:
a distribution circuit having:
a first differential NPN transistor pair to coupled to a pulse generator via their bases, the first differential NPN transistor pair being coupled to a current sink via their emitters to sink a predetermined current to a reference signal via their emitters;
a second differential NPN transistor pair, the emitters of the second differential NPN transistor pair being coupled to the collectors of the first differential NPN transistor pair via respective first and second resistors, the collectors of the second differential NPN transistor pair being coupled to the power source, and the bases of the of the second differential NPN transistor pair being coupled to a first switching circuit; and
one or more signal generators coupled to the distribution circuit, the signal generators having one or more switches to selectively enable a first write mode or a second write mode, the switches having:
a third differential NPN transistor pair, the emitters of the third differential NPN transistor pair being coupled to the respective collectors of the first differential NPN transistor pair, the collectors of the third differential NPN transistor pair being coupled to a power source via respective first and second resistors, and the bases of the of the third differential NPN transistor pair being coupled to a second switching circuit; and
a fourth differential NPN transistor pair, the base of the fourth differential NPN transistor pair being coupled to the respective collectors of the first differential NPN transistor pair, the emitters being coupled to the reference signal via respective second and third current sinks, the collectors of the fourth differential NPN transistor pair being coupled to the power source.

17. A servo writer as defined in claim 16, further comprising a buffer having first and second differential inputs, the first differential input being coupled to the respective emitters of the third differential NPN transistor pair and a third switching circuit, and the second differential input being coupled to the respective emitters of the fourth differential NPN transistor pair and a fourth switching circuit.

18. A servo writer as defined in claim 16, wherein, in response to an operating condition signal, the first and second switching circuits are to selectively enable one of the first write mode and the second write mode.

19. A servo writer as defined in claim 18, wherein, in response to the first write mode, the first switching circuit is to turn off the second differential NPN transistor pair and cause the signal generators and the second switching circuit is to turn on the third differential pair, wherein the third differential pair is to provide the predetermined current to the first differential pair in response to a channel operating condition signal.

20. A servo writer as defined in claim 18, wherein, in response to the second write mode, the first switching circuit is to turn on the second differential NPN transistor pair and cause the signal generators to have a voltage mode, wherein the second switching circuit is to turn off the third differential pair and the fourth switching circuit is to turn on is response.
